(19) United States
(12) Patent Application Publication
(10) Pub. No.: US 2014/0258305 A1
(43) Pub. Date: Sep. 11, 2014

(54) SYSTEMS AND METHODS FOR PROVIDING CONTEXTUAL TRUST SCORES

(71) Applicants: Kalpesh Gopaldas KAPADIA, Palo Alto, CA (US); Michael Rourk HALLINAN, Davis, CA (US)

(72) Inventors: Kalpesh Gopaldas KAPADIA, Palo Alto, CA (US); Michael Rourk HALLINAN, Davis, CA (US)

(73) Assignee: TREMUS, INC. D/B/A TRUSTFACTORS, INC., Palo Alto, CA (US)

(21) Appl. No.: 14/198,330

(22) Filed: Mar. 5, 2014

Related U.S. Application Data
(60) Provisional application No. 61/773,612, filed on Mar. 6, 2013.

(51) Int. Cl. G06F 17/30

(52) U.S. Cl. CPC G06F 17/3053; G06F 17/30312
USPC 707/741; 707/749

(57) ABSTRACT

The disclosed embodiments include methods and systems for providing contextual trust scores. The disclosed embodiments include, for example, a system for providing a contextual trust score including a memory storing software instructions and one or more processors configured to execute the software instructions. In one aspect, the one or more processors may be configured to perform operations including receiving a user scenario associated with a user. The operations may also include selecting one or more key variables from one or more data sources based on the user scenario, and may measure the key variables across one or more contextual dimensions. The operations may further include comparing the results of the measuring, and generating a contextual trust score associated with a user. The operations may also include continuously monitoring the data sources, updating the generated trust score, and providing the update trust score to the user or a third party.

### CROSS-REFERENCE TO RELATED APPLICATIONS

This application claims the benefit of U.S. Provisional Application No. 61/773,612, filed Mar. 6, 2013, which is herein incorporated by reference in its entirety.

### BACKGROUND

1. Technical Field

The disclosed embodiments generally relate to systems and methods for providing information, and more particularly, and without limitation, to systems and method for providing contextual trust scores.

2. Background

Trust is an important aspect and value in our society that drives the fundamentals of personal and business relationships, social interactions, self-understanding, and many other interactions. In certain environments, trust may reflect a reliance on the integrity, strength, ability, and surety of a person or thing or the confidence or credibility in or of such person or thing. Establishing and verifying trust has been a problem for some time as judgment is often riddled with human bias and misunderstanding. Information related to trust understanding and education regarding individuals, groups of individuals, business, etc., is routinely investigated through the Internet and other media. For example, information reflecting a level of trust may often be general purpose in nature and viewable by consumers using publically available websites, social networks or market places, such as Match.com or LinkedIn. However, the veracity and accuracy of the source and content as well as the context and relevance of such information may vary and is hard for individual actors to judge and create actionable insight around.

Certain aspects of the disclosed embodiments incorporate, monitor, and/or verify numerous data sources across several contextual dimensions to generate context-driven trust scores based on a system and methodology to account for data that is accurate, complete, and timely. In certain aspects, the disclosed embodiments provide trust scores that are purpose-built, contextual, and privately accessible in order to answer specific business questions or verify certain behaviors (e.g., driving habits or calories burnt). In certain embodiments, a contextual trust score may reflect information about a specific individual, groups of individuals, organization, business, etc. that may be driven by the context of an inquiry about the such specific person or business. In certain embodiments, a contextual trust score may reflect information about a target individual that may be driven by such individual's desire for deeper self-understanding to help in assessing behaviors and values. In certain aspects, contextual trust scores may be applicable in different industries, such as the consumer credit industry, human resource management, business-to-consumer applications, peer-to-peer or social commerce, and online directories or social networks. Certain aspects of the disclosed embodiments may be configured to contextualize, define, quantify, measure, score, and/or monitor trust, and may also provide mechanisms for rewarding participation in the trust score systems and processes consistent with the disclosed embodiments. For example, in certain aspects, positive behaviors may result in discounts, special pricing, or favorable rates for consumers.

### SUMMARY

The disclosed embodiments include systems and methods for providing contextual trust scores. The disclosed embodiments may be configured to provide contextual trust scores based in part on rich online personal data, smartphones acting as broadband sensors, and advances in Big Data tools and techniques. The disclosed embodiments may be configured to define, measure, score, and monitor trust data and analytics to develop a complete, accurate, timely and data driven picture or mosaic of individuals or groups.

In certain aspects, the disclosed embodiments are configured to perform processes to account for trust in certain contexts, select key variables using an ontological trust model that may be configured to identify appropriate trust factors or variables, select an appropriate analytic (measurement), access a wide array of data sources (e.g., social web data, machine data, public records, etc.), compare results of trust score processes, and determine and publish a trust score via, for example, application programming interfaces based on applicable business, privacy, and security rules. In certain aspects, a trust score may represent a quantitative answer to a contextual question posed in a user scenario (e.g., the score will provide a numerical measure from which to answer the question).

Certain disclosed embodiments may perform analytic cycles that may include a continuous process providing information about a specific user. In some aspects, the analytic cycle may include understanding the trust context, harvesting web or machine data, performing contextual analytics, publishing findings, and monitoring for significant events. In certain aspects, the trust scoring system and methodology may be configured to function as a socio-technical system that intelligently combines online data (e.g., profile attributes or biography/beliefs, etc.) with off-line behaviors (e.g., time, place, devices, etc.) and human interactions with the system to calculate trust scores.

In certain aspects, the disclosed embodiments may provide users with incentives and rewards in order to elicit greater levels of participation in the trust score processes of the disclosed embodiments. The disclosed embodiments may be configured to provide information that a user or entity may use to have greater self-understanding, social benchmarking, and benefit from trust rewards. With greater levels of user engagement of the trust score system and processes, users and entities (including businesses) may receive a benefit of understanding individual users and therefore develop tailored pricing, products, or services to specific individuals or groups of individuals.

The disclosed embodiments include, for example, a computer-implemented method for providing a trust score. The method may include receiving, by a trust score system, a user scenario corresponding to a user, the received user scenario designed to assess a measure of the user in a particular context. The method may also include selecting, by the trust score system, one or more key variables associated with a user from one or more data sources in accordance with a trust data model based on the user scenario. The method may further include measuring, by the trust score system, the one or more key variables across one or more contextual dimensions, the one or more contextual dimensions reflecting one or more aspects of the user's life. The method may include comparing, by the trust score system, results of the measuring against other measured data. The method may also include generating, by the trust score system, a trust score based on the comparison, the trust score reflecting a quantitative answer to the contextual question represented in the user scenario. The method may also include continuously monitoring, by the trust score system, the one or more data sources for a change in the one or more key variables. The method may also include updating, by the trust score system, the generated trust score based on a first change in the one or more key variables. The method may also include providing, by the trust score system, the updated trust score for presentation to a client or third party computer system.

The disclosed embodiments also include, for example, a system for providing a contextual trust score. The system may include a memory storing software instructions and one or more processors coupled to the memory, the one or more processors configured to execute the software instructions. The processors may be configured to receive a user scenario corresponding to a user, the received user scenario designed to assess a measure of a user in a particular context. The processors may also be configured to select one or more key variables associated with a user from one or more data sources in accordance with a trust data model based on the user scenario. The processors may also be configured to measure the one or more key variables across one or more contextual dimensions, the one or more contextual dimensions reflecting one or more aspects of the user's life. The processors may also be configured to compare the results of the measuring against other measured data. The processors may also be configured to generate a trust score based on the comparison, the trust score reflecting a quantitative answer to the contextual question represented in the user scenario. The processors may also be configured to continuously monitor the one or more data sources for a change in the one or more key variables. The processors may also be configured to update the generated trust score based on a first change in the one or more key variables. The processors may also be configured to provide the updated trust score for presentation to a client or third party computer system.

The disclosed embodiments may also include, for example, a system for providing a contextual trust score. The system may include a memory storing software instructions and one or more processors coupled to the memory, the one or more processors configured to execute the software instructions. The processors may be configured to obtain, from a first inquiring source, a first inquiry regarding a first user, the first inquiry requesting an assessment of a measure of the first user in a first context. The processors may also be configured to determine a set of key variables associated with the first user based on the first inquiry. The processors may also be configured to obtain the set of key variables from determined data sources based on the first inquiry. The processors may also be configured to measure the obtained key variables across a set of contextual dimensions reflecting aspects of the first user's life. The processors may also be configured to generate a contextual trust score for the first user based on the measured key variables. The processors may also be configured to provide the contextual trust score for the first user to the first inquiring source.

Additional objects and advantages of the disclosed embodiments will be set forth in part in the description which follows, and in part will be obvious from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments as claimed. In certain aspects, while certain features of the disclosed embodiments may be described in connection with certain contextual dimensions, key variables, system configurations, etc., the contemplated systems and methods relating to the disclosed embodiments may involve other types of dimensions, variables, and configurations, including those exemplified below.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1 depicts an exemplary computing environment consistent with the disclosed embodiments.

FIG. 2 depicts a block diagram of an exemplary system including data source systems consistent with the disclosed embodiments.

FIG. 3 depicts a block diagram of exemplary key variables storages consistent with the disclosed embodiments.

FIG. 4 depicts a block diagram of an exemplary trust score system consistent with the disclosed embodiments.

FIG. 5 depicts a block diagram of an exemplary data grid consistent with the disclosed embodiments.

FIG. 6 depicts an exemplary contextual trust score computing system consistent with the disclosed embodiments.

FIG. 7 depicts a block diagram of an exemplary system for generating a trust score consistent with the disclosed embodiments.

FIG. 8 depicts a block diagram of an exemplary system for providing a multi-dimensional contextual trust score consistent with the disclosed embodiments.

FIG. 9 depicts an exemplary interface consistent with the disclosed embodiments.

FIG. 10 depicts a flowchart for an exemplary contextual trust score generation and reward process consistent with the disclosed embodiments.

FIG. 11 depicts a flowchart for an exemplary contextual trust score generation and update process consistent with the disclosed embodiments.

FIG. 12 depicts a flowchart for an exemplary contextual trust score updating process consistent with the disclosed embodiments.

FIG. 13 depicts a flowchart for an exemplary baselining, benchmarking, and rewarding process consistent with the disclosed embodiments.

FIG. 14 depicts a flowchart for an exemplary contextual trust score updating and reward process consistent with the disclosed embodiments.

FIG. 15 depicts a flowchart for an exemplary contextual trust score user scenario process consistent with the disclosed embodiments.

### DESCRIPTION OF THE EMBODIMENTS

Reference will now be made in detail to embodiments, examples of which are illustrated in the accompanying drawings. Wherever possible, the same reference numbers will be used throughout the drawings to refer to the same or like parts.

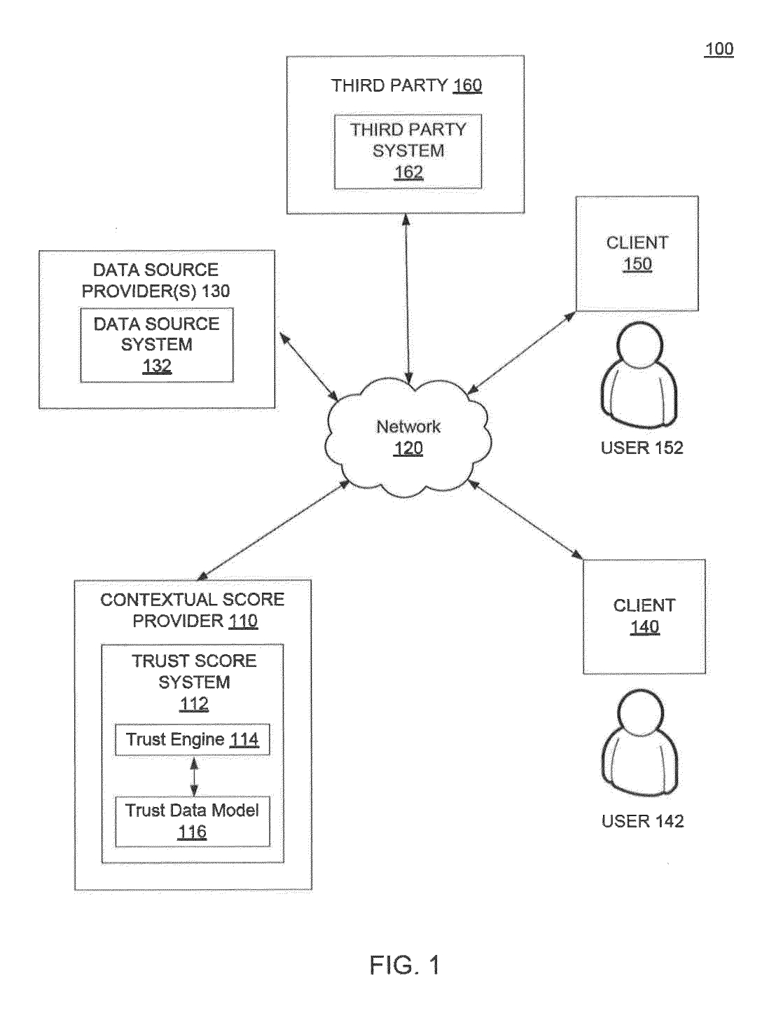

FIG. 1 illustrates an exemplary computing environment 100 consistent with certain disclosed embodiments. In one aspect, computing environment 100 may include one or more clients (e.g., clients 140 and 150) which may be associated with respective one or more users (e.g., users 142 and 152), one or more third party systems (e.g., system 162) which may be associated with one or more third parties (e.g., third party 160), one or more data source systems (e.g., data source system 132) which may be associated with one or more data source provider(s) (e.g. data source provider(s) 130), and a trust score system (e.g., system 112) which may be associated with a contextual trust score provider (e.g., provider 110). A communications network 120 (e.g., the Internet) may connect one or more of the components of computing environment 100.

While FIG. 1 illustrates computing environment with only two clients 140 and 150 (associated with users 142 and 152, respectively), the disclosed embodiments may include additional clients and users. Moreover, a user may associate with one or more clients, and a client may associate with one or more users. Similarly, while FIG. 1 depicts computing environment 100 with a single trust score system 112, third party system 162, and data source system 132, one of ordinary skill in the art will appreciate that environment 100 may include any number of such systems communicating with each other over network 120.

Client 140 may be associated with one or more users or one user on multiple clients. Client 140 may include any computer system configured to execute processes consistent with the disclosed embodiments (e.g., a smartphone). In some embodiments, client 140 may include one or more broadband sensors to obtain off-line behavior data (e.g., data not obtainable via online data source systems) such as time, place, and “pattern of life” information associated with user 142 consistent with the disclosed embodiments. Client 150 may be configured similar to that described above for client 140. For example, client 150 may be associated with one or more users (e.g., user 152) and may include any computer system configured to execute processes consistent with the disclosed embodiments (e.g., a smartphone).

Third party systems 162 may represent one or more computer systems associated with a third party 160. In certain aspects, third party 160 may represent a person or entity that may have an interest in or communicates with a user (e.g., user 142, user 152, etc.). For example, third party system 162 may be a computer system of an underwriter of consumer credit or consumer risk, such as a bank lender, credit card company, insurer, financial institution, or the like. In another example, third party system 162 may be a computer system associated with human resource managers to perform credential verifications on user 142. In other embodiments, third party system 162 may be a computer system associated with business-to-consumer applications, such as Salesforce.com. In addition, third party system 162 may be a computer system associated with a peer-to-peer commerce or social commerce solution such as Match.com, eHarmony.com, and AngiesList.com. In other aspects, third party system 162 may be a computer system for online people directories or social networking systems such as LinkedIn, Facebook, or MySpace. Third party systems 162 may consist of computing components such as servers, processors, and memories consistent with the disclosed embodiments.

In certain aspects, third party 160 may reflect an individual or entity that requests trust scores from trust score provider 110. For instance, a credit card company may request a level of trust associated with a potential customer based on a specific inquiry. A user may also request trust scores from trust score provider regarding a level of trust associated with him/herself or another user, based on a specific inquiry. The disclosed embodiments may be configured to provide trust scores based on the context of the inquiry (e.g., what is a user's driving habits, credit risk, dating potential, etc.).

Data source provider(s) 130 may reflect an entity (or entities) that provide data that is used by trust score system 112 to perform processes consistent with the disclosed embodiments. For example, a data source provider 130 may reflect a public or private entity that maintains, provides, or the like, information regarding a user, business, etc. (e.g., user 142, user 152, a company, etc.). In certain aspects, data source provider(s) 130 may represent a public entity (e.g., department of motor vehicles), a judicial entity (e.g., a state court entity, federal court entity, etc.), private entity (e.g., financial service provider, credit score provider, social network provider, etc.). Examples of data sources are explained further in accordance with certain aspects of the disclosed embodiments. Data source system 132 may be a computing system that is associated with data source provider(s) 130 that performs known computing processes for providing access to information obtained and maintained by data source provider(s) 130.

In some embodiments, client 140 or client 150, or third party systems 162, may provide data to trust score system 112, and thus may be considered a data source system 132. For example, in one aspect, trust score system 112 may receive information from client 140 that may be used to perform trust score processes consistent with disclosed embodiments. Thus, in this example, client 140 may operate consistent with that of a data source system 132.

In one embodiment, contextual score provider 110 (or trust score provider) may be any type of entity (e.g., a business, etc.) that provides trust score services to one or more users (e.g., users 142 and 152), groups of users, and/or third parties 160, consistent with the disclosed embodiments.

Trust score system 112 may be a computing system that is associated with contextual score provider 110, although the disclosed embodiments are not limited to such an association. For example, trust score system 112 may be a computing system that is associated with, used by, operated by, etc., a user or users that have no association with contextual score provider 110. In some embodiments, trust score system 112 may include one or more computing devices (e.g., servers, etc.), one or more processors, and one or more memory storages. The computing device(s) may store one or more software programs, such as a software application (e.g., a web service), executed by one or more processors included in trust score system 112. In some embodiments, trust score system 112 may be configured to execute software instructions stored in memory to perform one or more processes consistent with the disclosed embodiments. In some embodiments, trust score system 112 may communicate with users 142 and 152 through clients 140 and 150, respectively, over communications network 120. In certain aspects, trust score system 112 may also communicate with a third party system 162 over communications network 120.

Trust score system 112 may include one or more memory storages configured to store information consistent with the disclosed embodiments. In some embodiments, the memory storages may store software instructions that, when executed by one or more processors, perform processes consistent with the disclosed embodiments. In some aspects, the memory storages may store information obtained from one or more data source systems 132, clients 140, and/or third party systems 162.

Trust score system 112 may be configured to obtain information over network 120. In certain aspects, trust score system 112 may obtain and store information from one or more data source systems 132, clients 140, and/or third party systems 162. In some aspects, trust score system 112 may obtain information from data source systems 132 that are neither a client 140 nor a third party system 162.

In some embodiments, trust score system 112 may obtain information that relates to a user scenario. In some aspects, a user scenario may represent a question designed to assess the measure of a user in a particular context. In some aspects, the context may have a specific purpose. In one embodiment, a specific context may reflect a specific question about a user. For example, a specific-purpose context may reflect a specific business question corresponding to a user (e.g., the credit risk of a user), a specific behavioral question (e.g., a user's driving habits, calories burnt in a day, etc. specific self-understanding question (e.g., how can I improve my sleep?), or the like. In other embodiments, the context may be general-purpose in nature, and may not be directed to a specific question. For example, a general-purpose context may be designed to assess a generalized measure of a user not directed to a specific question. In certain aspects, the disclosed embodiments may be configured to consider and process general-purpose contexts and specific-purpose contexts.

In certain aspects, trust score system 112 may be configured to obtain information that may include one or more key variables. In one embodiment, a key variable may include information about a user pertaining to a user scenario (e.g., information relevant to the context of the user scenario). For example, in some aspects, key variables may include the user's biographical information, such as her name, address, birthday, age, gender, height, weight, etc. Key variables may also include educational and intellectual information associated with a user, such as a user's educational level, school, degrees, etc. In some aspects, key variables may also reflect employment or professional information associated with user 142 such as employment data, occupation, or the like. Key variables may also include information related to a user's health such as weight, weekly exercise hours, etc. In certain embodiments, key variables may comprise information relating to the user's home life such as her marital status, number of children, etc. Key variables may also include financial information including a user's income, home-ownership, etc. In some embodiments, key variables may further relate to a user's social information such as a number of Facebook connections, marital status, number of children, or any of the other variables discussed above.

In some aspects, the key variables may include any kind of information consistent with the disclosed embodiments. For instance, the disclosed embodiments may obtain, generate, use, and process other types of key variables such as license information (e.g., professional license information, driver's license information, FAA/FCC license information, hunting and fishing license data, health care providers or sanctions, DEA registrants, etc.), court and legal information (e.g., bankruptcy filings, criminal or civil things, judgments and liens, marriage and divorce records, OSHA inspection reports, OFAC sanctions, etc.), and the like.

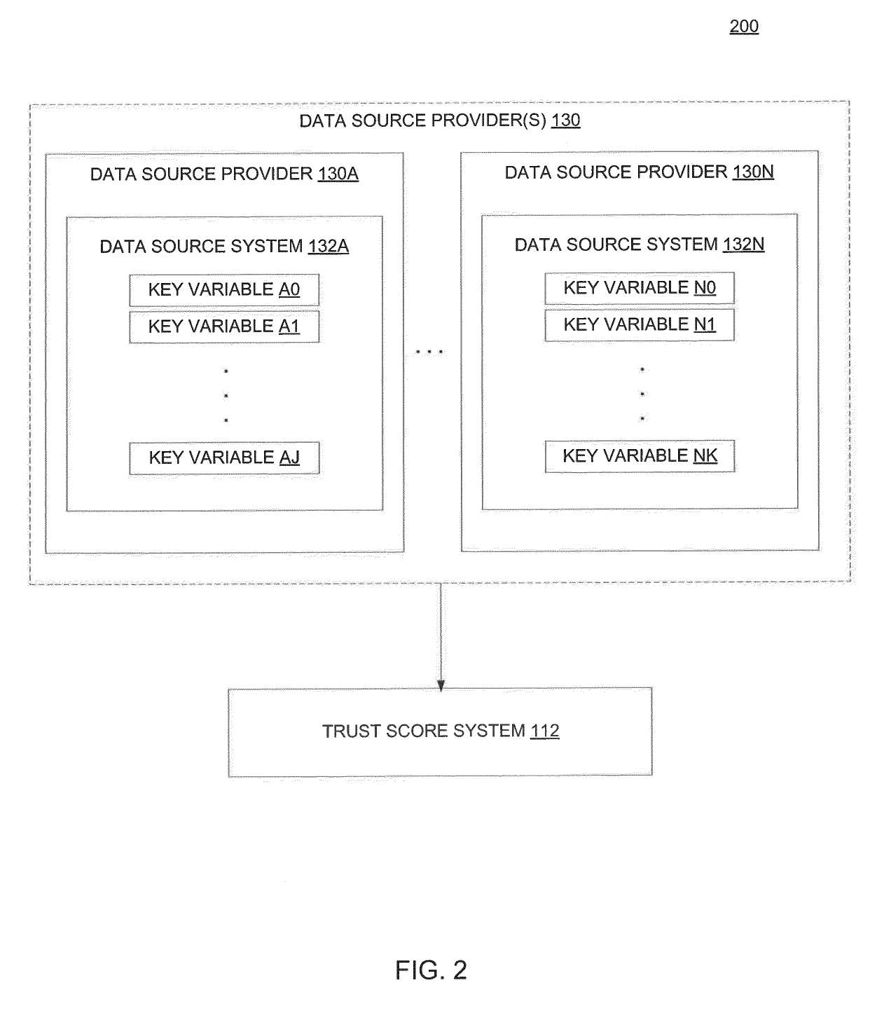

FIG. 2 depicts a block diagram of an exemplary system including data source systems consistent with the disclosed embodiments. In the exemplary data source configuration 200, one or more data source data source systems 132A through 132N may be associated with one or more data source provider(s) 130A through 130N. In some aspects, data source systems 132A-132N may store one or more key variables associated with a user 142 relevant to a given user scenario. Each data source system 132 may include any number of key variables. For example, as depicted in FIG. 2, data source system 132A may include exemplary key variables A0 through AJ, while data source system 132N may include exemplary key variables N0 through NK, where K need not equal J. In some embodiments, a key variable may also reside in a plurality of data source systems (e.g., data source systems 132A and 132N). For example, a user's employment information may reside in a system associated with her Facebook, Match.com, and LinkedIn accounts. In one aspect, trust score system 112 may be configured to obtain a key variable stored in a plurality of data source systems to verify the value of the key variable consistent with the disclosed embodiments.

In some embodiments, trust score system 112 may be configured to obtain one or more key variables from the one or more data source systems 132A-132N consistent with the disclosed embodiments. For instance, client 140, acting as a data source, may provide information to trust score system 112 over network 120 (e.g., over the Internet). In some aspects, for example, trust score system 112 may be configured to activate sensors or synchronize data from sensors on client 140 to obtain information from the client (e.g., time, place, and pattern data). In other embodiments, trust score system may obtain information from data source systems 132 not relating to client 140.

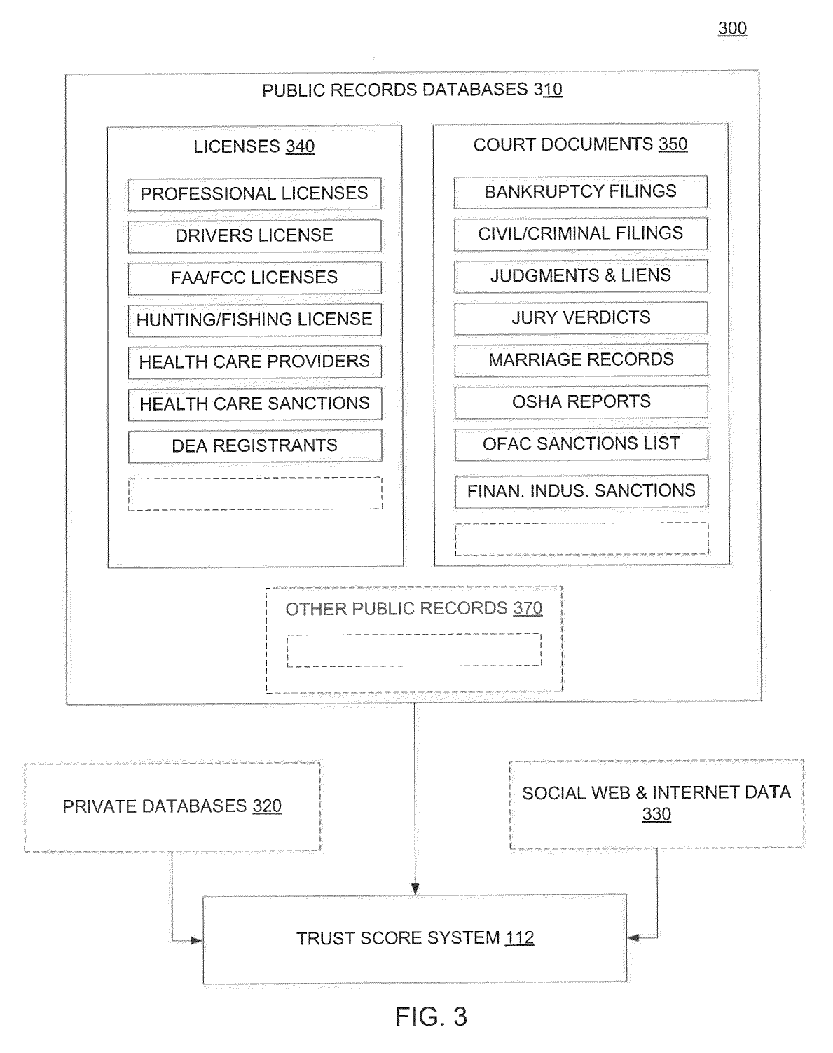

As an illustration of one exemplary embodiment, FIG. 3 depicts a block diagram of exemplary key variable sources consistent with the disclosed embodiments. In this example, trust score system 112 may obtain one or more key variables from one or more of public records databases 310, private databases 320, and/or social web and/or Internet data 330. By way of example, public records databases 310 may include license information 340, court documents and filings 350, and other public records 370 relating to a user (e.g., user 142). In certain aspects, key variables within public license information 340 may include, for example, professional license information, driver's license information, FAA/FCC license information, hunting and fishing license data, health care providers or sanctions, DEA registrants, and the like. Additionally, public court documents and filings 350 might include key variables reflecting bankruptcy filings, criminal and civil filings, judgments, liens, marriage and divorce records, OSHA inspection reports, OFAC sanctions, financial industry sanctions, and so on.

Trust score system 112 may be configured to obtain one or more key variables from other public sources 370, private databases 320, or social web and Internet data 330. For instance, trust score system 112 may obtain a user's employment, income, or education information from public databases 370, social web data 330, or private databases 320, in addition to other sources not illustrated (e.g., client 140).

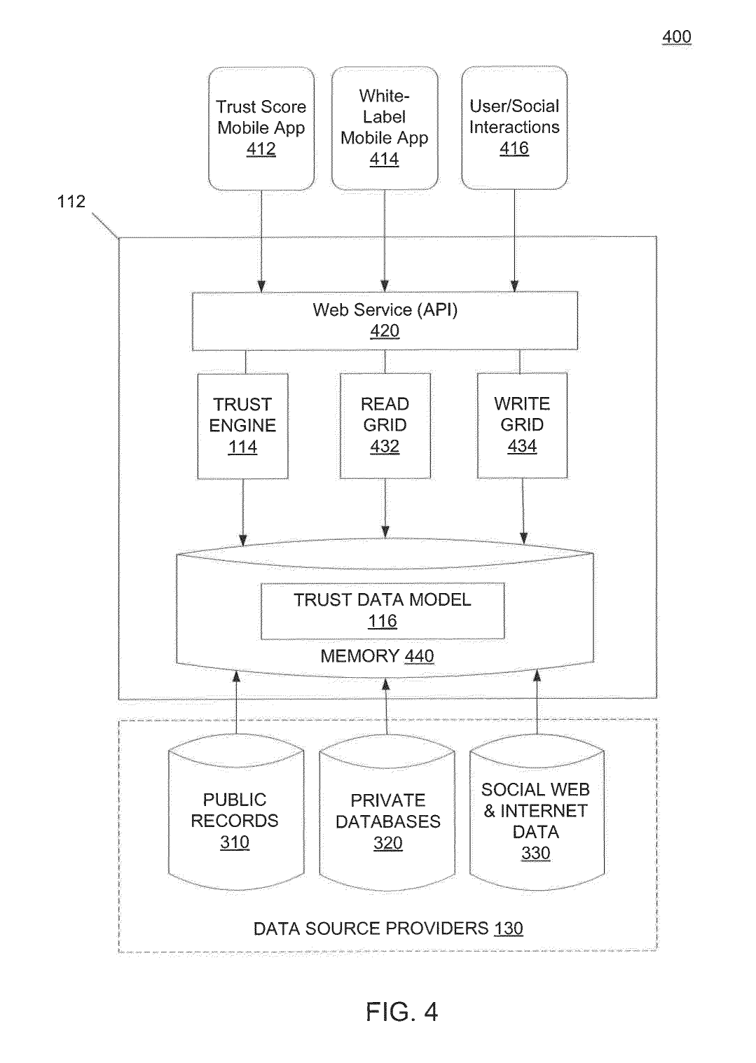

FIG. 4 depicts a block diagram of an exemplary trust score system 112 consistent with the disclosed embodiments. In some embodiments, trust score system 112 may include a trust data model 116 stored in memory 440. In some aspects, the trust data model 116 may represent a model configured to handle the selecting, obtaining, storing, and indexing of key variables from one or more data source systems 132. For example, trust data model 116 may represent a model configured to handle the selecting and indexing of one or more key variables from a number of data source providers 130 such as public records 310, private databases 320, and social web and internet data 330.

In certain embodiments, trust score system 112 may interface with other computer systems through a web service application programming interface (API) 420. In some aspects, API 420 may specify how software components of different systems interact with one another, and may allow trust score system 112 to obtain and provide information to other computer systems. For instance, in some embodiments, trust score system 112 may interface with client 140 through a trust score mobile application 412 that may be executing on client 140. In these embodiments, trust score system 112 may obtain and provide information (e.g., user scenarios, key variables, etc.) from/to client device 140 through API 420. In another embodiment, trust score system 112 may interface with client 140 (or client 150) through a white-label mobile application 414.

In other aspects, API 420 may provide an interface between trust score system 112 and a user's social interactions 416. In certain embodiments, trust score system 112 may be configured to validate certain key variables by monitoring a user's social or web interactions through API 420. For example, trust score system 112 may be configured to gauge the extent to which a user's social or web interactions comport with the key variables, and update the key variables stored within trust data model 116 based on the results of the validation.

In some embodiments, trust score system 112 may also provide access to a people directory via an index published on the web (e.g., a web index of all users of the trust score system 112).

In some embodiments, trust score system 112 may store key variables in trust data model 116 in the form of a data grid. In some aspects, the data grid may consist of a database containing information related to the key variables. In one embodiment, trust score system 112 may read and write values to the data grid using read grid 432 and write grid 434 processes, respectively. Read grid 432 may be configured to read values from the stored data grid, and write grid 434 may be configured to write (e.g., add) and overwrite (e.g., modify) values stored in the data grid.

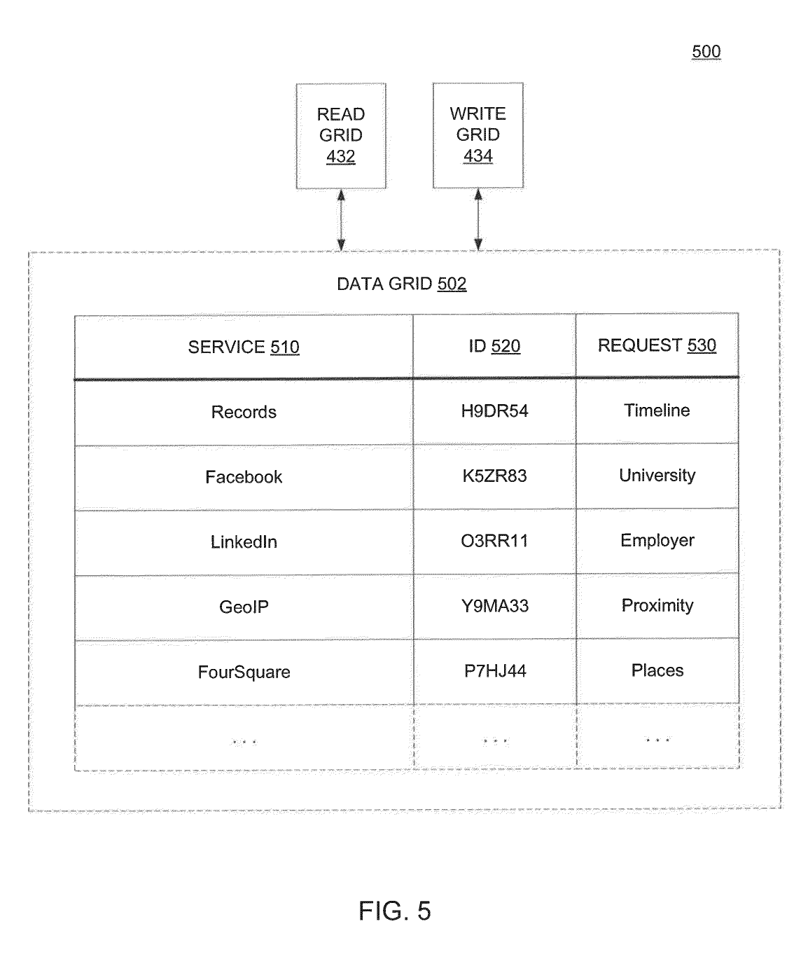

FIG. 5 depicts a block diagram of an exemplary data grid consistent with the disclosed embodiments. In this exemplary environment 500, read grid instructions 432 and write grid instructions 434 may read and write information, respectively, to exemplary data grid 502. In one aspect, the information stored in data grid 502 may consist of key variables (e.g., shown as rows) corresponding to user 142. In some embodiments, data grid 502 may include data values reflecting a source of a key variable as indicated in service column 510. For example, in FIG. 5, data grid 502 may store key variables from Records, Facebook, LinkedIn, Internet Protocol based geographic location reference (GeoIP), and FourSquare, etc., as indicated in service column 510. In certain embodiments, data grid 502 may also include an ID 520 uniquely identifying the key variable.

Data grid 502 may also include a request 530 for each key variable. Request 530 may represent an explanatory or human-readable description of the key variable found within the data source associated with service 510. In FIG. 5, for example, data grid 502 includes request 530 denoted “University” in one exemplary key variable. In this example, the key variable includes service 510 denoted “Facebook” with ID 520 number K5ZR83, uniquely identifying this key variable from others stored within data grid 502. These values may indicate that trust data model 116 has selected and/or obtained a key variable reflecting a university associated with user 142 from a Facebook data source system 132, and the system has assigned the key variable a particular identification number ID 520.

Returning briefly to FIG. 4, in some aspects, trust score system may include a trust engine 114 in communication with trust data model 116. In some embodiments, trust engine 114 use trust data model 116 to generate a trust score for a user. In certain aspects, a trust score may represent a quantitative answer, determination, or measure for a contextual question posed in a user scenario. For example, a contextual trust score may represent a quantitative assessment of a user's driving habits, credit risk, credential verification, calories burnt, etc.

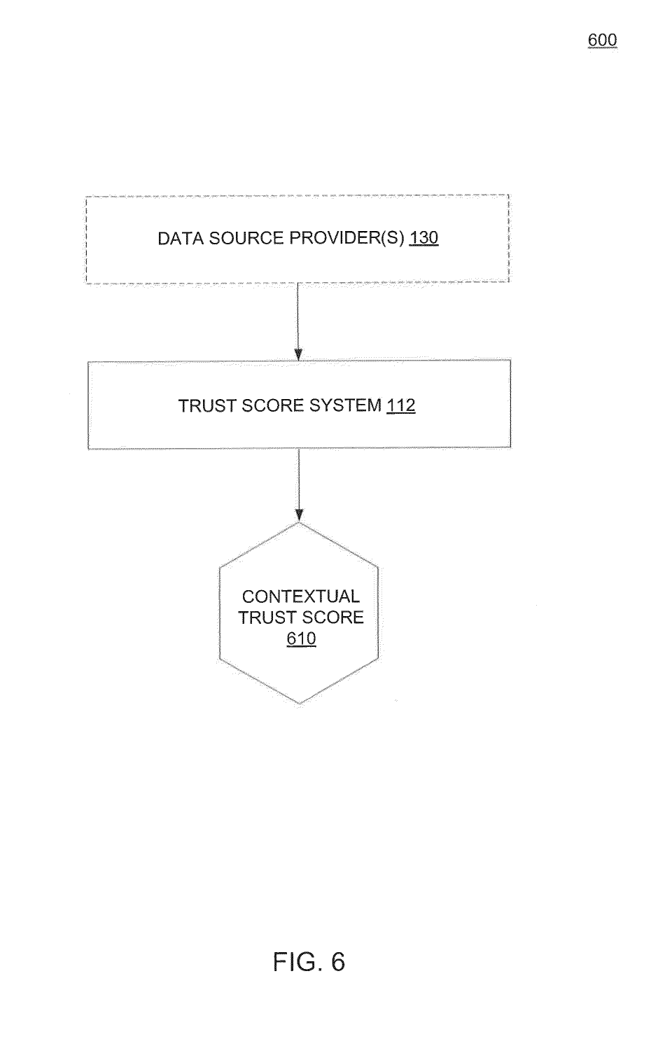

FIG. 6 depicts a block diagram of an exemplary contextual trust score computing system 600 consistent with the disclosed embodiments. In some aspects, trust score system 112 may obtain a user scenario for a user 142, and select one or more key variables from one or more data source systems 132 in accordance with trust data model 116 based on the user scenario. In certain embodiments, the key variables and data source systems may depend on the user scenario obtained by the trust score system 112 (e.g., whether the trust score reflects a general-purpose context or specific-purpose context). Trust score system 112 may be configured to obtain the key variables consistent with the disclosed embodiments. The trust score system 112 may include a trust engine 114 configured to use trust data model 116 to generate a contextual trust score 610 corresponding to a user (e.g., user 142) for a particular user scenario.

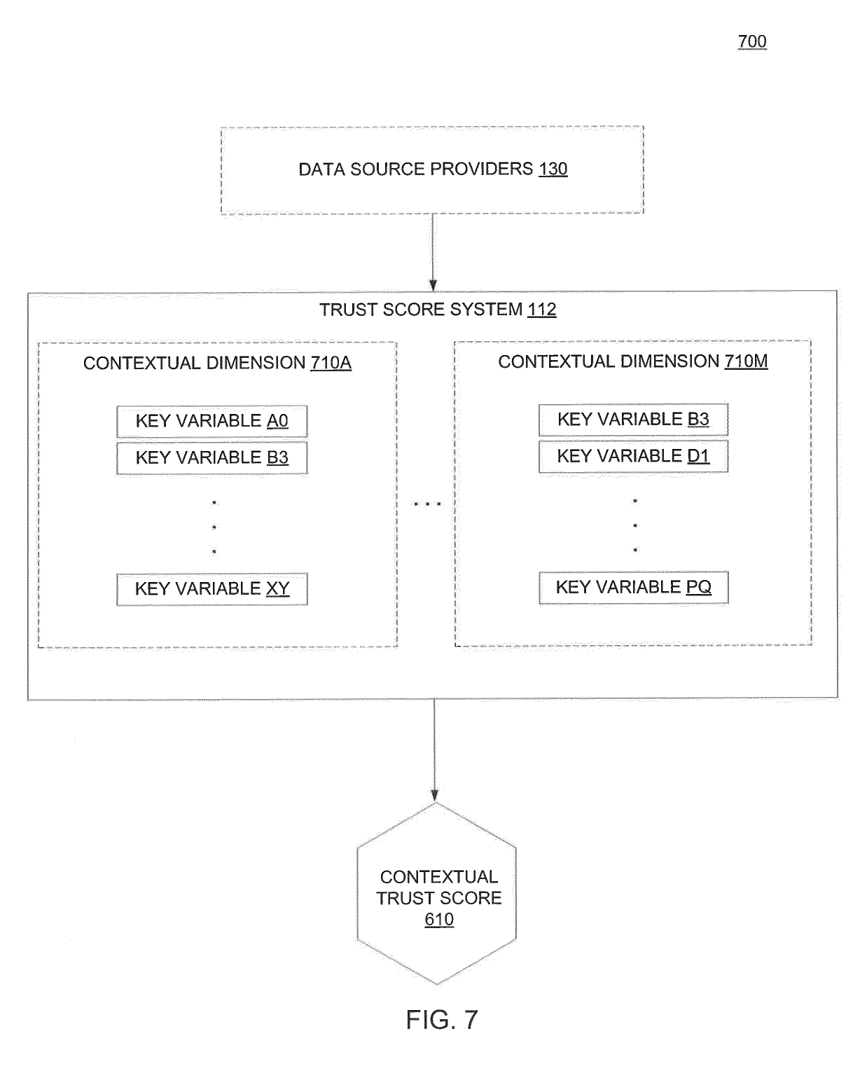

FIG. 7 depicts a block diagram of an exemplary system for generating a trust score consistent with the disclosed embodiments. As previously discussed, in certain embodiments, trust score system 112 may obtain a user scenario corresponding to user 142. In one aspect, the trust score system 112 may obtain key variables from one or more data source systems 132 based on the user scenario. In some aspects, trust score system 112 may generate a contextual trust score 610 by relating the key variables to one or more contextual dimensions 710A-710M. In one embodiment, a contextual dimension may reflect one or more classes of data representing particular aspects of a user's life. For example, exemplary contextual dimensions may include a user's intellectual, professional, financial, home, social, and/or health life. In other aspects, trust score system 112 may relate a single key variable to one or more contextual dimensions. For example, a user's employment data may correspond to her professional life contextual dimension, social life contextual dimension, and financial life contextual dimension, while her eight may relate to her social life contextual dimension and health life contextual dimension, etc. Consistent with the disclosed embodiments, trust score system 112 may be configured to define and manage the number and kinds of contextual dimensions it uses to generate a contextual trust score 610 for a particular user scenario.

For example, in the exemplary environment 700 of FIG. 7, trust score system may relate key variables A0, B3, . . . XY with contextual dimension 710A, and key variables B3, D1, . . . , PQ with contextual dimension 710M. As indicated in FIG. 7, in some embodiments, trust score system 112 may relate the same key variable (e.g., key variable B3) with one or more contextual dimensions (e.g. contextual dimensions 710A and 710M). Consistent with the disclosed embodiments, trust score system may use these relationships to generate a contextual trust score 610 for a particular user scenario. In other aspects, trust score system 112 may be configured to generate trust score 610 based on business rules, privacy rules, and/or security rules. In some aspects, trust score 610 may be generated as a numerical value or some other representation. For example, trust score 610 may comprise a single number (e.g., 75), or a set of numbers comprising a plurality of values (e.g., {40, 59, 32}). In some embodiments, trust score system 112 may also be configured to verify certain key variables used to generate trust score 610. In certain aspects, for instance, the trust score system 112 may verify a key variable by selecting it from multiple data sources 132, thereby validating the key variable's value. In some embodiments, this verification may affect the value(s) of the generated trust score 610.

In certain embodiments, trust score system 112 may generate trust score 610 by comparing key variables associated with a subject of the trust score (e.g., user 142) with key variables associated with other users (e.g., user 152). For example, trust score system 112 may generate a trust score for a user by benchmarking key variables associated with the user's salary, health, happiness, etc., against those of others stored within trust data model 116.

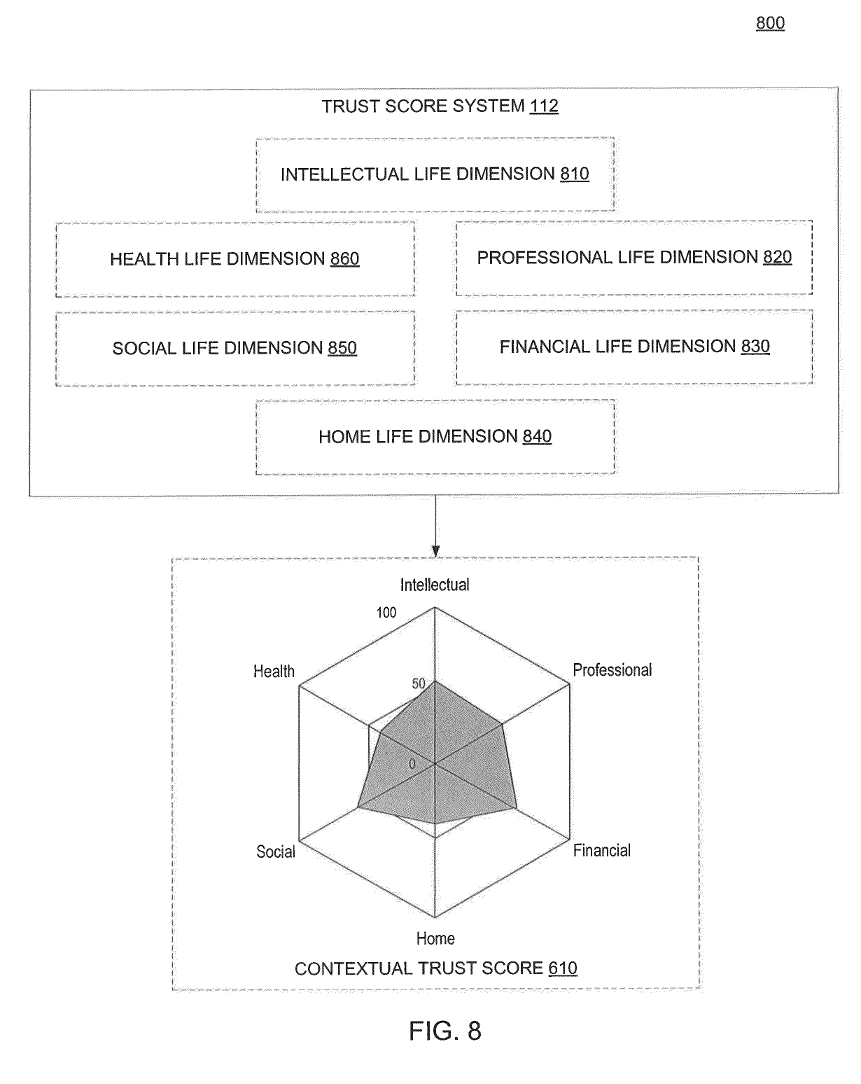

FIG. 8 depicts a block diagram of an exemplary system for providing a multi-dimensional contextual trust score 610 consistent with the disclosed embodiments. In this exemplary environment 800, trust score system 112 relates one or more key variables (not shown) among six contextual dimensions 810-860. For example, trust score system 112 may associate key variables with one or more of intellectual life dimension 810, professional life dimension 820, financial life dimension 830, home life dimension 840, social life dimension 850, and health life dimension 860. By way of example, trust score system 112 may associate a key variable representing a user's weekly exercise hours with social life 850 and health life 860. As previously discussed, the key variables may depend on a user scenario provided to trust score system 112 (e.g., a general-purpose context or a specific-purpose context).

In certain aspects, trust score system 112 may generate a contextual trust score 610 based on the stored key variables and their relationship to the one or more contextual dimensions 810-860. For example, trust score system 112 may be configured to generate a six-dimensional trust score 610, as exemplified in FIG. 8. The six-dimensional trust score may reflect, for example, six quantitative ratings corresponding to the six contextual dimensions 810-860 of environment 800. In other embodiments, trust score system 112 may be configured to generate a trust score 610 comprising a single number. In the exemplary system of FIG. 8, the ratings may be assessed on a scale of 0-100. In other aspects, trust score 610 of environment 800 may include overlays of different scores having different ratings (e.g., the shaded portion of trust score 610 in FIG. 8). Aspects of the disclosed embodiments may be configured to generate and present trust scores (single or overlayed scores) in a manner consistent with the contextual trust score 610 shown in FIG. 8.

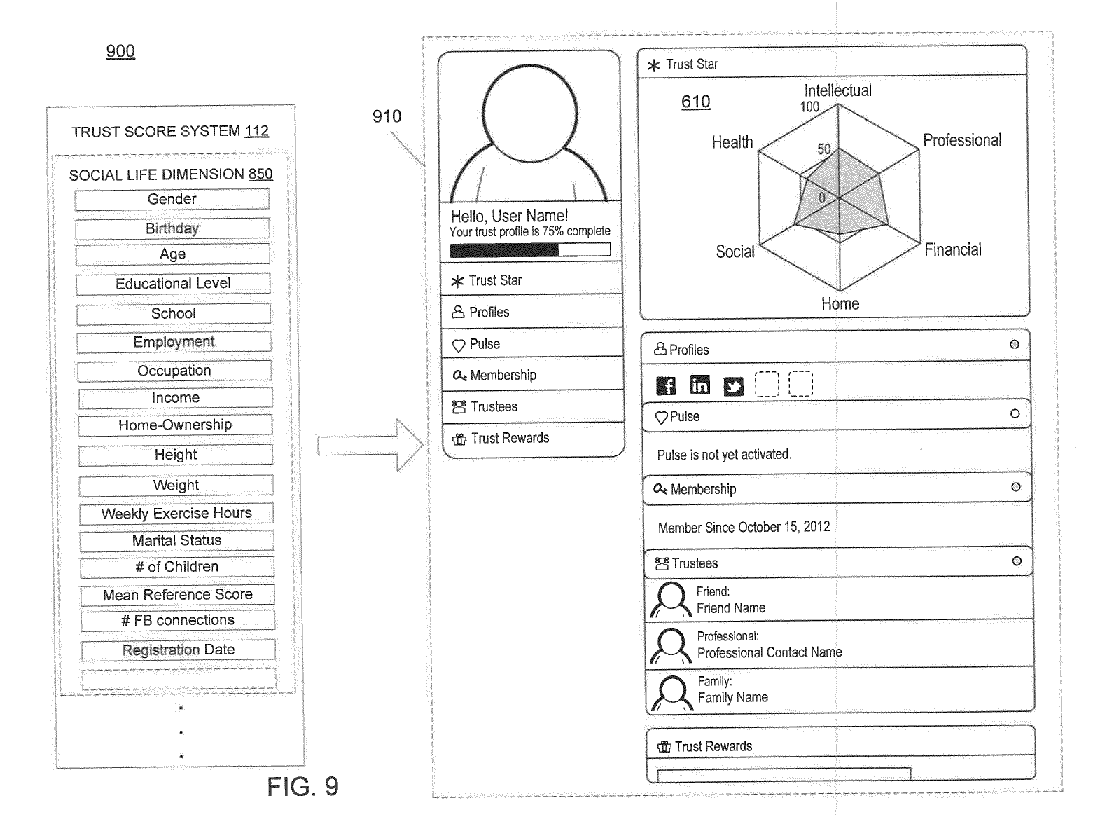

FIG. 9 depicts an exemplary interface consistent with the disclosed embodiments. FIG. 9 shows one manner in which the trust score created consistent with the multi-dimensional trust score described in connection with exemplary system 800 of FIG. 8, although the disclosed embodiments are not limited to such representations or types of trust scores. In some embodiments, for instance, trust score system 112 may be configured to publish a generated trust score 610 consistent with the disclosed embodiments to a digital forum (e.g., via API 420) having an interface 910. In certain embodiments, the digital forum may consist of a publicly or privately available website configured to display a trust score. For example, in some aspects, the digital forum may comprise a publicly available website, social network, or online marketplace (e.g., Match.com or LinkedIn). In other embodiments, the digital forum may consist of a privately-accessible website not available to the general public. In some embodiments, trust score system 112 may determine whether to publish the generated trust score 610 to a public or private forum based on, for example, whether the user scenario associated with trust score 610 reflects a general-purpose context or a specific-purpose context. For example, if a user scenario associated with trust score 610 reflects a specific-purpose context, trust score system 112 may be configured to publish the trust score 610 to a privately accessible forum only. In other embodiments, the disclosed embodiments may consider this determination based on other factors such as, for instance, other business, privacy, and security rules consistent with the disclosed embodiments.

In certain aspects, trust score system 112 may publish trust scores 610 using API 420. The API 420 may be configured to provide a trust score 610 to a digital forum in such a way as to make it capable of being viewed in the interface of the forum 910. Also, as explained, trust score system 112 may include, consider, and generate a trust score 610 based on key variables associated with certain dimensions. For example, as shown in FIG. 9, trust score system 112 may consider the key variables listed in social life dimension 850. In other aspects, trust score system 112 may be configured to publish a trust score 610 via API 420 based on business rules, privacy rules, and/or security rules,

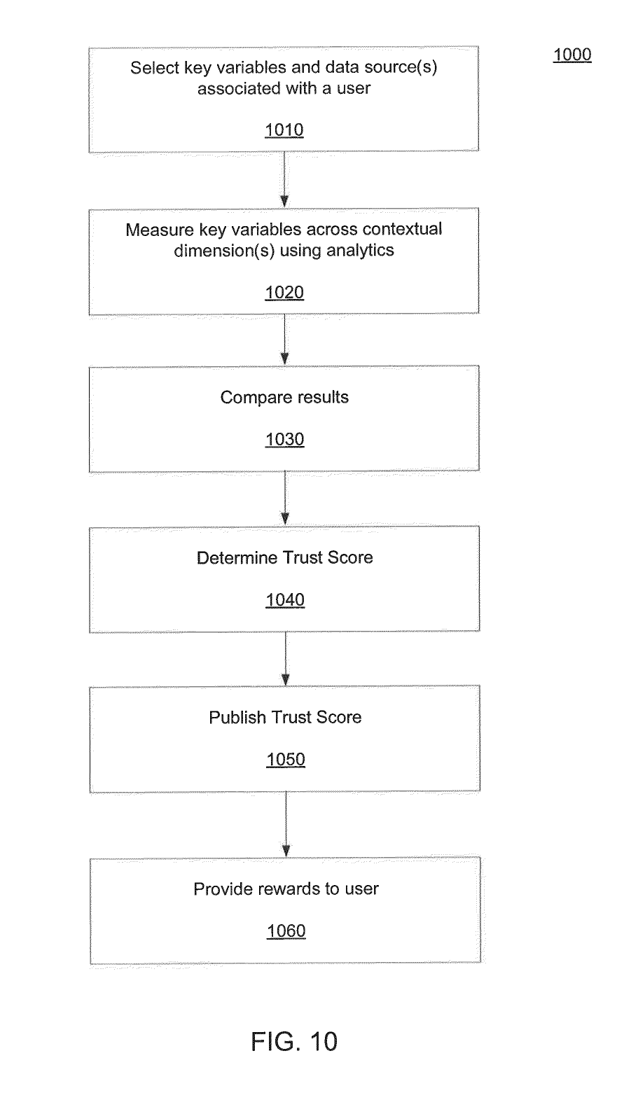

FIG. 10 depicts a flowchart for an exemplary contextual trust score generation and reward process 1000 consistent with the disclosed embodiments. In some aspects, exemplary method 1000 may provide the functionality enabling trust score system 112 to generate a trust score for publishing in a digital forum with exemplary interface 910 or other types of interfaces. In one embodiment, trust score system 112 may be configured to execute software instructions to obtain a user scenario consistent with the disclosed embodiments. In some embodiments, trust score system 112 may select one or more key variables from one or data sources associated the user 142 based on the obtained user scenario (step 1010). For example, in certain aspects, the system may select the one or more key variables from one or more data source systems 132 in accordance with a trust data model 116 based on the context of the user scenario. Trust score system 112 may also be configured to measure (e.g., obtain and analyze) the key variables across one or more contextual dimensions, the contextual dimensions reflecting certain aspects of the user's life, consistent with the disclosed embodiments (step 1020).

In some embodiments, trust score system 112 may compare the results of the measuring by benchmarking key variables associated with a user (e.g., user 142) with key variables associated with other users (e.g., user 152) (step 1030). For instance, in some embodiments, trust score system 112 may compare information related to a user's salary, happiness, health, etc., against others in order to generate a contextual trust score 610. In some aspects, trust score system 112 may generate a trust score based on the key variables, their relationship to the contextual dimensions, and the comparison with other users of the trust score system 112 (step 1040). In certain embodiments, trust score system 112 may publish the generated trust score to a digital forum using API 420 consistent with the disclosed embodiments (step 1050). For example, trust score system 112 may publish the trust score to a marketing website, social networking website, or private website. In certain aspects, client 140 and/or third party system 162 may be configured to portray information published to the digital forum (e.g., through interface 910).

In some aspects, trust score system 112 may be configured to provide one or more rewards to user 142 (step 1060). In some embodiments, the provided rewards may comprise, for instance, gift cards, discounts at certain retailers, special pricing options, favorable rates at certain service providers, special products, or special services. In certain aspects, the extent and nature of the rewards may depend on the user's generated trust score and level of participation with the trust score system 112. In some embodiments, a user's level of participation with trust score system 112 may reflect the amount of information client 140 provides to trust score system 112. In other aspects, the rewards provided by trust score system 112 may depend on other information consistent with the disclosed embodiments. For example, in one embodiment, the rewards provided to user 142 may correspond to a particular business, product, or service of a third party 160 requesting a trust score for the user 142. By way of example, a third party car insurance agency 160 may request a specific-purpose trust score for user 142 directed to the user's driving habits. In this example, trust score system 112 may be configured to provide user 142 with optimized insurance rates, pricing, or tailored offers based on the generated trust score and the nature of the car insurance agency's business.

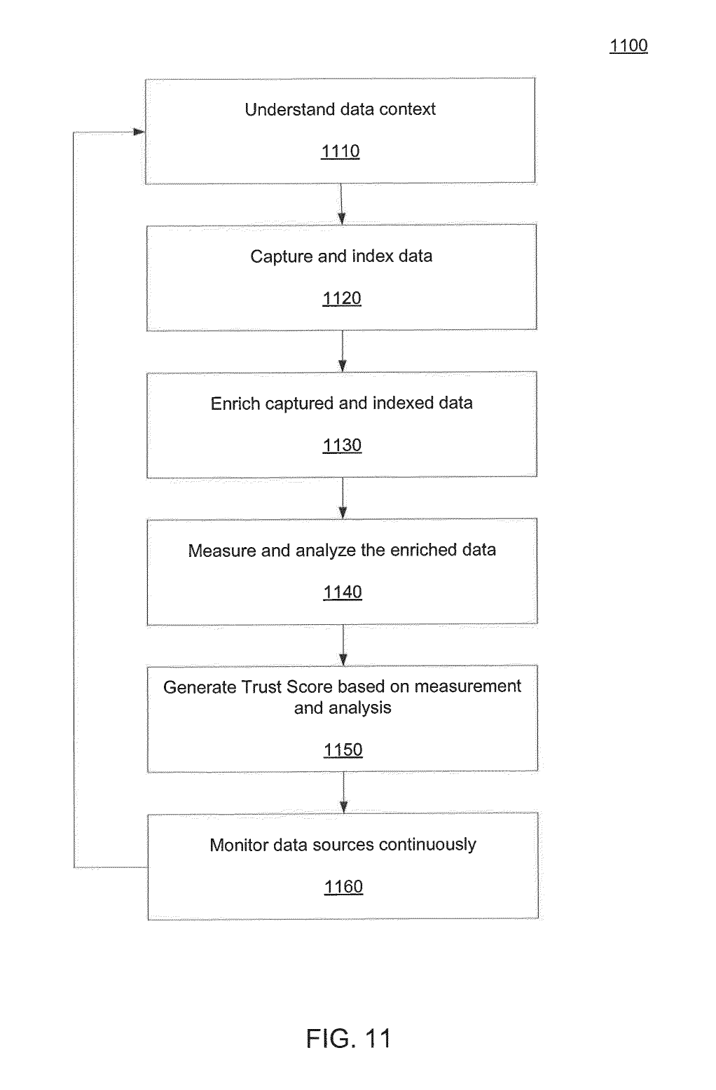

FIG. 11 depicts a flowchart for an exemplary contextual trust score generation and update process 1100 consistent with the disclosed embodiments. In some aspects, exemplary method 1100 may provide the functionality enabling trust score system 112 to generate and update a contextual trust score 610 through continuously monitoring data source systems 132 for changes to key variables. In some embodiments, trust score system 112 may be configured to understand the context governing how trust score 610 should be calculated (step 1110). This may include, for example, receiving a user scenario from client 140 or third party system 162. Consistent with the disclosed embodiments, the user scenario may reflect, for example, a general-purpose context or a specific-purpose context (e.g., a specific business question or behavioral question).

In one aspect, trust score system 112 may be configured to select key variables from one or more data sources 132 in accordance with a trust data model 116 governed by the user scenario obtained in step 1110. For example, trust score system may be configured to obtain key variables from one or more data source systems 132. In other embodiments, trust score system 112 may be configured to activate sensors on client 140 and obtain key variables reflecting off-line behaviors such as time, place, and device information consistent with the disclosed embodiments.

In some embodiments, trust score system 112 may capture and index the key variables consistent with the disclosed embodiments (step 1120). Trust score system 112 may also be configured to enrich the captured and indexed data (step 1130). In some aspects, trust score system 112 may enrich the captured and indexed data by, for example, verifying and/or validating one or more key variables associated with user 142 consistent with the disclosed embodiments. For example, trust score system 112 may monitor a user's social interactions to determine whether the user's interactions comport with the key variables associated with the user stored in trust data model 116. Trust score system 112 may also enrich the captured and indexed data by receiving key variables based on interactions with client 140.

In certain aspects, trust score system 112 may be configured to measure and analyze the enriched data (step 1140). In some embodiments, trust score system 112 may analyze the enriched data by performing a computational factor analysis on the key variables. In one aspect, the computational factor analysis may include analyze each of the key variables across one or more contextual dimensions based on the user scenario from obtained in step 1110. For example, in one embodiment, the computation factor analysis may relate a user's “income” key variable to “social life” and “financial life” contextual dimensions in response to a general-purpose user scenario. In other aspects, the computational factor analysis may consist of other calculations consistent with the disclosed embodiments (e.g., performing analyses on key variables for a specific-purpose user scenario). In certain embodiments, trust score system 112 may be configured to generate a trust score 610 based on the measurement and analysis of the enriched data in the computational factor analysis (step 1150).

Trust score system 112 may also be configured to continuously monitor the one or more data source systems 132 for changes in one or more key variables (step 1160). For example, trust score system 112 may be configured to continuously activate the sensors on client 140 to obtain information thereon. In another example, trust score system 112 may be configured to continuously monitor the data source system 132 consistent with public records, private databases, and other web and internet data. In some embodiments, changes in the key variables may help trust score system 112 better determine the data context and user scenario governing how trust score 610 should be calculated, and the process may begin anew (step 1110).

In some embodiments, the monitoring process may allow trust score system 112 to update a previously generated trust score 610 (e.g., as a result in a change in a key variable). In certain aspects, trust score system 112 may be configured to republish an updated trust score 610 to a digital forum consistent with the disclosed embodiments. In some aspects, for example, the trust score system 112 may update and republish a trust score 610 so that the published score and supporting data remains timely, complete, and accurate. Trust score system 112 may be configured to provide additional functionality with an updated trust score not depicted in the exemplary process 1100. For example, in some aspects, trust score system 112 may be configured to provide additional rewards to a user based on an updated trust score consistent with the disclosed embodiments (e.g., as in the exemplary process 1000).

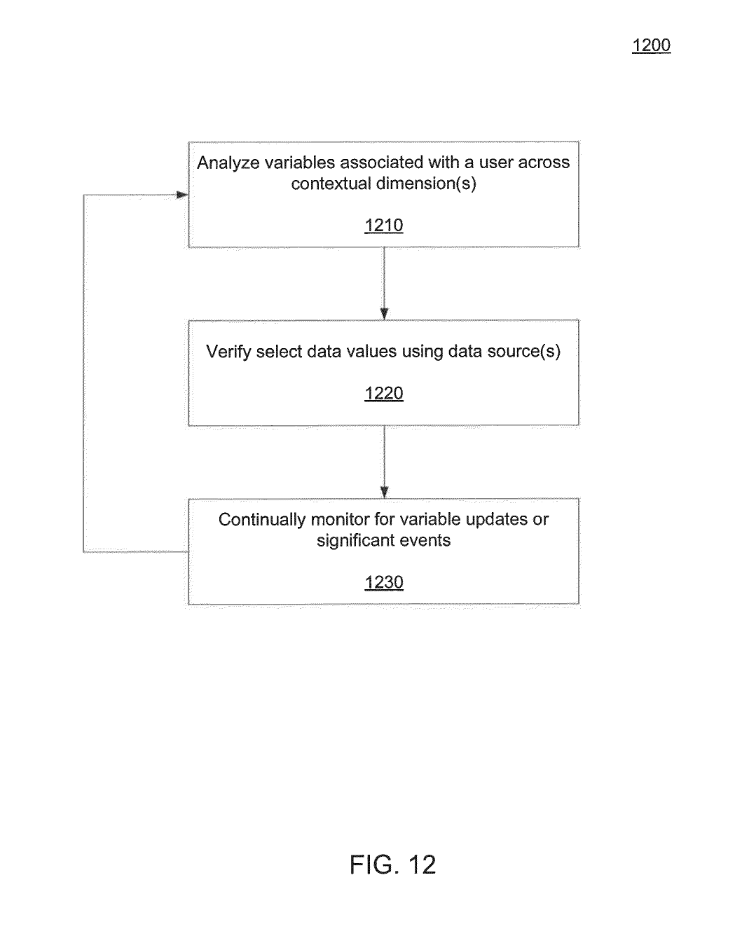

FIG. 12 depicts a flowchart for an exemplary contextual trust score updating process consistent with the disclosed embodiments. In some aspects, exemplary method 1200 may provide the functionality enabling trust score system 112 to verify and validate data values and continuously monitor data source systems 132 for changes to key variables. In some aspects, trust score system 112 may be configured to execute software instructions to select and analyze one or more key variables associated with a user across one or more contextual dimensions consistent with the disclosed embodiments (step 1210). In some embodiments, the system may be configured to verify certain key variables by, for instance, measuring an identified subset of key variables from multiple data source systems 132. In certain aspects, a key variable selected from multiple may be considered verified by trust score system 112. Additionally or alternatively, trust score system 112 may be configured to validate certain key variables by monitoring the user's social interactions (e.g., social interactions 416) using API 420 consistent with the disclosed embodiments (step 1220). In some aspects, for example, trust score system 112 may continuously monitor data source systems 132 to maintain the key variables and generated trust score 610 as complete, accurate, and timely (step 1230). In some aspects, as the trust score system 112 continues to monitor the data sources, the system may update the variables as required, and relate the updated key variables across the contextual dimensions consistent with the disclosed embodiments (step 1210).

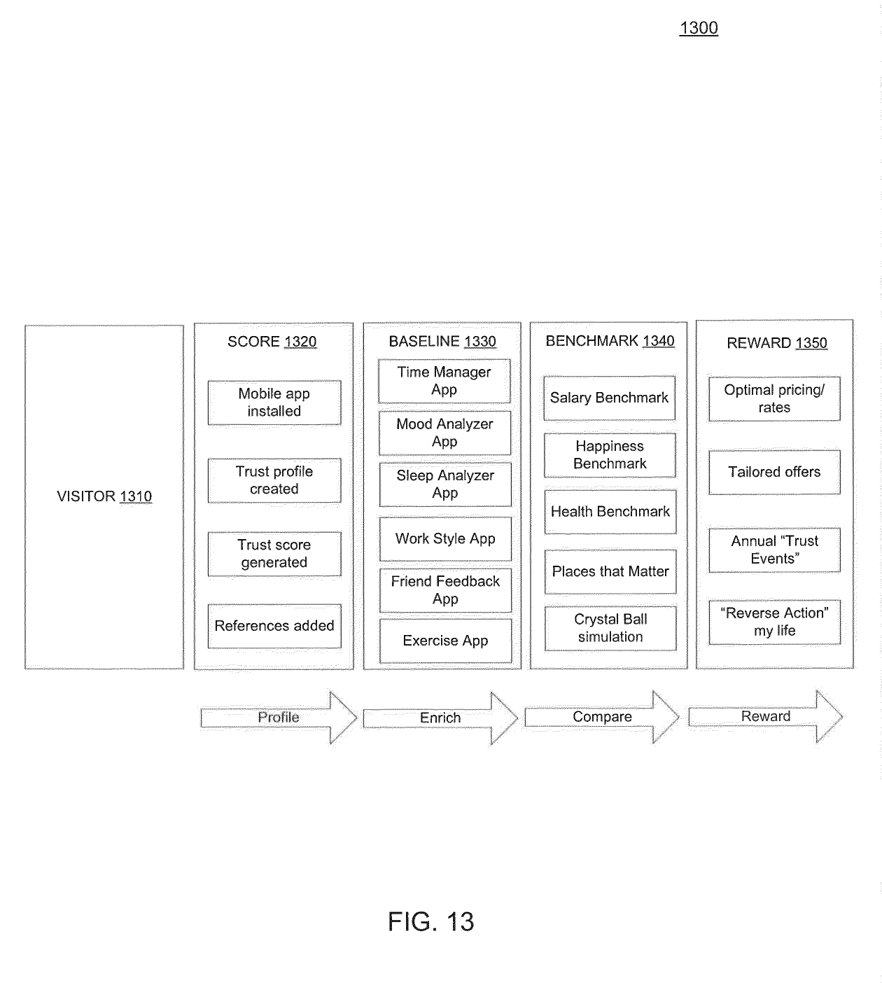

FIG. 13 depicts a flowchart for an exemplary baselining, benchmarking, and rewarding process consistent with the disclosed embodiments. In one aspect, exemplary method 1300 may provide the functionality enabling trust score system 112 to generate accurate a trust score 610 and provide rewards to a user. For example, trust score system 112 may perform a scoring process 1320 when client 140 installs a mobile application capable of performing processes consistent with the disclosed embodiments (e.g., a trust score mobile application 412). In some embodiments, client 140 may provide information input into the mobile application to trust score system 112 in order to generate a trust score 610. In some aspects, client 140 may provide additional information to trust score system 112 by providing references to other users of the trust score system (e.g., user 152) associated with user 142. In certain aspects, the process of scoring a user 1320 may differentiate a scored user from a visitor 1310 of the trust score system 112.

In some embodiments, trust score system 112 may be configured to interact with software applications executing on a client (e.g., client 140). These software applications may provide additional information (e.g., key variables) with which the trust score system 112 may baseline user 142 (process 1330). By way of example, trust score system 112 may interact with software applications directed to time management, mood analysis, sleep analysis, work style analysis, friend feedback, and exercise. Information obtained from these exemplary applications may be obtained by trust score system 112 in order to enrich the data stored in trust data model 116 consistent with the disclosed embodiments. In some aspects, the information obtained from the software application may affect a user's trust score in ways consistent with the disclosed embodiments. For example, a software application may constitute an additional data source from which key variables may be obtained and/or verified, thereby affecting a user's generated trust score (e.g. as in process 1100).

Trust score system 112 may also be configured to benchmark user 142 consistent with the disclosed embodiments (process 1340). In some embodiments, trust score system 112 may benchmark the user by comparing key variables associated with user 142 with those of users (e.g., user 152). For instance, trust score system 112 may compare information related to a user's salary, happiness, health, etc., to others, including comparing expected or simulated values, to benchmark user 142. In some embodiments, trust score system 112 may benchmark user 142 by assessing places of importance or comparing the user 142 against similarly situated users to generate a “crystal ball” simulation.

In some aspects, trust score system 112 may be configured to provide rewards to user 142 consistent with the disclosed embodiments (process 1350). For example, trust score system 112 may offer rewards to user 142 based on the user's level of participation with the system (e.g., the amount of information provided to trust scoring system 112), a user's current trust score (e.g., present value) or predicted future trust score (e.g., future value), etc. Rewards provided through trust score system 112 may comprise gift cards discounts at certain retailers, optimal pricing options and rate, tailored offers, special products, special services (e.g., “reverse auction” services), and access to annual “Trust Events.” The rewards process 1350 may be any kind of rewards process consistent with the disclosed embodiments.

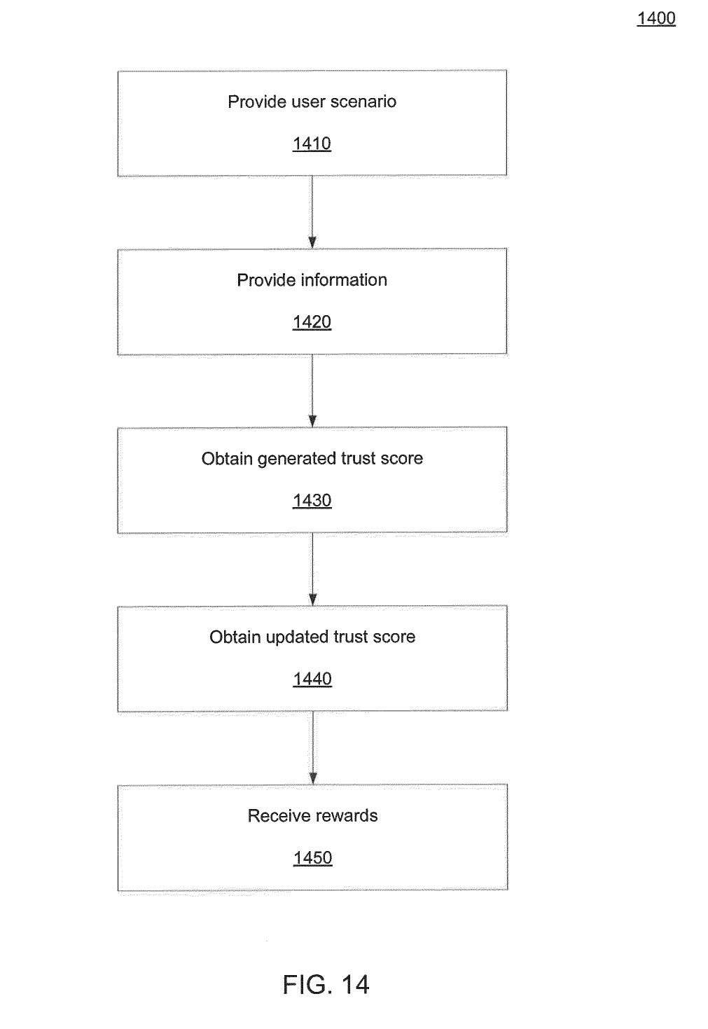

FIG. 14 depicts a flowchart for an exemplary contextual trust score updating and reward process 1400 consistent with the disclosed embodiments. In some embodiments, exemplary method 1400 may provide the functionality enabling client 140 to receive and access accurate trust scores 610. In one aspect, client 140 may provide the trust scoring system 112 with a user scenario consistent with the disclosed embodiments (step 1410). In some embodiments, client 140 may also provide to trust score system 112 information, or provide trust score system 112 access to information, (e.g., key variables) relating to user 142 (step 1420). In some aspects, client 140 may be configured to obtain a trust score generated by trust score system 112 (step 1430), the trust score 610 reflecting a quantitative answer to a contextual question posed in a user scenario. Consistent with certain embodiments, client 140 may be configured to receive an updated trust score 610 from trust score system 112 (step 1440), the updated trust score reflecting a trust score based on updated key variables stored within trust score system 112. In some aspects of the disclosed embodiments, client 140 may be configured to receive rewards provided by trust score system 112 consistent with the disclosed embodiments (step 1450). The rewards may be based, for instance, on the amount of information provided through client 140, the trust score, the updated trust score, or other information consistent with the disclosed embodiments. Rewards may include discounts, special pricing, or favorable rates for user 142.

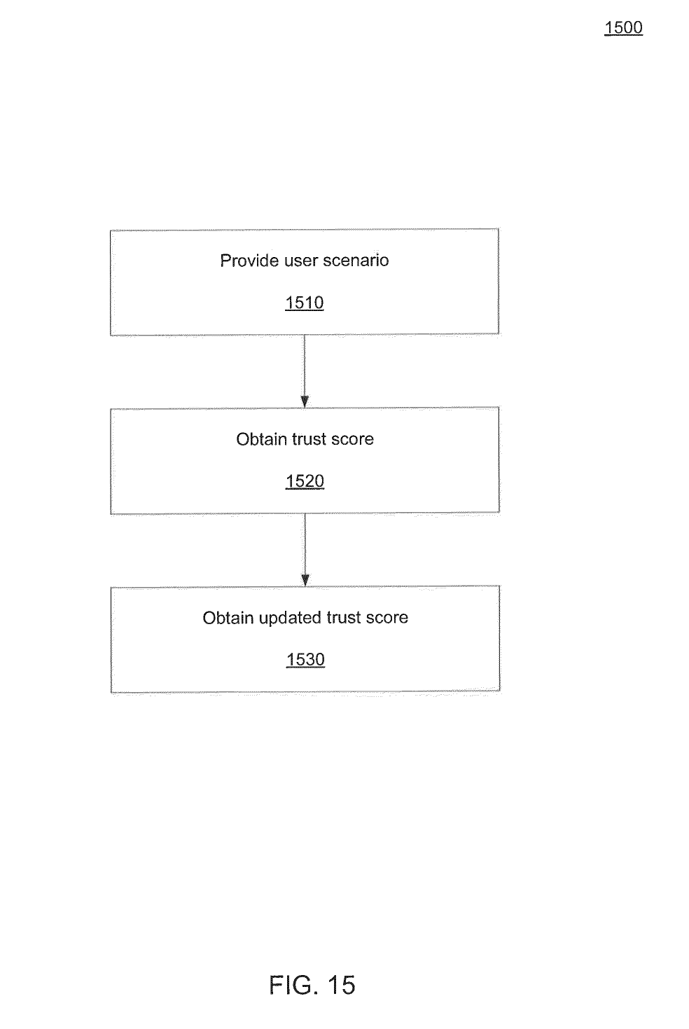

FIG. 15 depicts a flowchart for an exemplary contextual trust score user scenario process consistent with the disclosed embodiments. In certain aspects, exemplary method 1500 may provide the functionality enabling a third party system 162 to receive access to trust scores it requests from trust score system 112. In one aspect, third party system 162 may be configured to provide a user scenario corresponding to user 142 to trust score system 112 over network 120 (step 1510). For example, third party system 162 may be configured to send a request to trust score system 112 asking the system 112 to generate a trust score for a user reflecting a specific-purpose context (e.g., a user's credit risk, calories burnt, etc.). In some aspects of the disclosed embodiments, third party system 162 may be configured to obtain a trust score 610 generated from trust score system 112. Alternatively of additionally, third party system 162 may be configured to receive an updated trust score from trust score system 112 (step 1530) consistent with the disclosed embodiments, the updated trust score reflecting a trust score based on updated key variables stored within trust score system 112.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for providing a contextual trust score, comprising:
receiving, by a trust score system, a user scenario corresponding to a user, the received user scenario designed to assess a measure of the user in a particular context;
selecting, by the trust score system, one or more key variables associated with a user from one or more data sources in accordance with a trust data model based on the user scenario;
measuring, by the trust score system, the one or more key variables across one or more contextual dimensions, the one or more contextual dimensions reflecting one or more aspects of the user's life;
comparing, by the trust score system, results of the measuring against other measured data;
generating, by the trust score system, a trust score based on the comparison, the trust score reflecting a quantitative response to the user scenario;
continuously monitoring, by the trust score system, the one or more data sources for a change in the one or more key variables;
updating, by the trust score system, the generated trust score based on a first change in the one or more key variables; and
providing, by the trust score system, the updated trust score for presentation to a client or third party computer system.

2. The computer-implemented method of claim 1, further comprising:
providing, by the trust score system, one or more rewards to the user, the providing based on at least one of:
a participation level associated with the user, the participation level reflecting an amount of information provided by a client associated with the user,
the generated trust score,
the updated trust score, and
a predicted future trust score.

3. The computer-implemented method of claim 1, further comprising:
verifying, by the trust score system, identified data values from the one or more key variables, the verifying comprising at least one of:
selecting, by the trust score system, the identified data values from a plurality of the data sources, and
validating, by the trust score system, the identified data values by monitoring the user's social interactions; and
updating, by the trust score system, the generated trust score based on the verification.

4. The computer-implemented method of claim 1, further comprising:
providing, by trust score system, the generated trust score to a third party system; and
providing, by the trust score system, one or more rewards to the user based on the generated trust score, the one or more rewards corresponding to the third party system and including at least one of product discounts, service discounts, specialized rates, gift cards, or tailored offers.

5. The computer-implemented method of claim 1, wherein the particular context of the user scenario includes either a general-purpose context or a specific-purpose context.

6. The computer-implemented method of claim 1, wherein:
the user scenario is received from a client associated with the user; and
the particular context of the user scenario corresponds to a self-understanding question.

7. The computer-implemented method of claim 5, further comprising publishing, by trust score system, the generated trust score to a digital forum, the digital forum comprising a website, mobile application, social network, or online marketplace.

8. The computer-implemented method of claim 7, further comprising determining whether to publish the generated trust score to a publicly accessible or privately accessible digital forum based on at least one of business rules, privacy rules, security rules, and whether the user scenario includes a general-purpose or specific-purpose context.

9. The computer-implemented method of claim 1, wherein the generated trust score is based on the comparison and at least one of business rules, privacy rules, and security rules.

10. The computer-implemented method of claim 1, wherein the one or more data sources comprise at least one of public records, private databases, social media records, internet data, and data obtained from the client.

11. The computer-implemented method of claim 1, wherein the one or more contextual dimensions include intellectual life, professional life, financial life, social life, home life, and health life.

12. The computer-implemented method of claim 1, wherein the measuring the one or more key variables further comprises:
obtaining, by the trust score system, data associated with the user from the one or more data sources;
indexing, by the trust score system, the obtained data;
enriching, by the trust score system, the indexed data by verifying the one or more key variables within the indexed data; and
analyzing, by the trust score system, the enriched data by relating each of the one or more key variables among the one or more contextual dimensions.

13. The computer-implemented method of claim 1, wherein the comparing further includes benchmarking the user against one or more other users with respect to the one or more key variables.

14. The computer-implemented method of claim 1, wherein the user scenario represents a contextual question designed to assess the measure of the user in the particular context and wherein the generated trust score reflects a quantitative answer to the contextual question represented in the user scenario.

15. A system for providing a contextual trust score, comprising:
a memory storing software instructions; and
one or more processors coupled to the memory, the one or more processors configured to execute the software instructions to:
receive a user scenario corresponding to a user, the received user scenario designed to assess a measure of a user in a particular context;
select one or more key variables associated with a user from one or more data sources in accordance with a trust data model based on the user scenario;
measure the one or more key variables across one or more contextual dimensions, the one or more contextual dimensions reflecting one or more aspects of the user's life;
compare the results of the measuring against other measured data;
generate a trust score based on the comparison, the trust score reflecting a quantitative response to the user scenario;
continuously monitor the one or more data sources for a change in the one or more key variables;
update the generated trust score based on a first change in the one or more key variables; and
provide the updated trust score for presentation to a client or third party computer system.

16. The system of claim 15, wherein the one or more processors are further configured to provide one or more rewards to the user based on at least one of:
a participation level associated with the user, the participation level reflecting an amount of information provided by a client associated with the user,
the generated trust score,
the updated trust score, and
a predicted future trust score.

17. The system of claim 15, wherein the one or more processors are further configured to:
verify identified data values from the one or more key variables, including at least one of:
selecting the identified data values from a plurality of the data sources, and
validating the identified data values by monitoring the user's social interactions; and
update the generated trust score based on the verification.

18. The system of claim 15, wherein the particular context of the user scenario includes either a general-purpose context or a specific-purpose context.

19. The system of claim 15, wherein:
the user scenario is received from a client associated with the user; and
the particular context of the user scenario corresponds to a self-understanding question.

20. The system of claim 18, wherein the one or more processors are further configured to:
publish the generated trust score to a digital forum, the digital forum comprising a website, mobile application, social network, or online marketplace; and
determine whether to publish the generated trust score to a publicly accessible or privately accessible digital forum based on at least one of business rules, privacy rules, security rules, and whether the user scenario includes a general-purpose context or specific-purpose context.

21. The system of claim 15, wherein the generated trust score is based on the comparison and at least one of business rules, privacy rules, and security rules.

22. The system of claim 15, wherein the one or more processors are configured to measure the one or more variables by:
obtaining data associated with the user from the one or more data sources;
indexing the obtained data;
enriching the indexed data by verifying the one or more key variables within the indexed data; and
analyzing the enriched data by relating each of the one or more key variables among the one or more contextual dimensions.

23. The system of claim 15, wherein the user scenario represents a contextual question designed to assess the measure of the user in the particular context and wherein the generated trust score reflects a quantitative answer to the contextual question represented in the user scenario.

24. A system for providing a contextual trust score, comprising:
a memory storing software instructions; and
one or more processors coupled to the memory, the one or more processors configured to execute the software instructions to:
obtain, from a first inquiring source, a first inquiry regarding a first user, the first inquiry requesting an assessment of a measure of the first user in a first context,
determine a set of key variables associated with the first user based on the first inquiry,
obtain the set of key variables from determined data sources based on the first inquiry,
measure the obtained key variables across a set of contextual dimensions reflecting aspects of the first user's life,
generate a contextual trust score for the first user based on the measured key variables, and
provide the contextual trust score for the first user to the first inquiring source.

25. The system of claim 24, wherein the first inquiring source is one of the first user, a second user, or a third party entity.

26. The system of claim 25, wherein the third party entity is a business:
obtaining data associated with the user from the determined data sources.

27. The system of claim 25, wherein the determined data sources comprise at least one of a public records data source, a private databases data source, and a social media records data source.

28. The system of claim 27, wherein the set of contextual dimensions include one or more of an intellectual life dimension, a professional life dimension, a financial life dimension, a social life dimension, a home life dimension, and a health life dimension.

29. The system of claim 27, wherein the one or more processors are configured to provide rewards to the first user based on a level of participation by the first user in trust scoring processes provided by the system.
